(19) United States
(12) Patent Application Publication
(10) Pub. No.: US 2017/0270727 A1
(43) Pub. Date: Sep. 21, 2017

(54) COMMUNICATION SYSTEM, CONTROL DEVICE, AND AUTHENTICATION INFORMATION DETERMINATION METHOD

(71) Applicant: Alps Electric Co., Ltd., Tokyo (JP)

(72) Inventor: Akira MIYAZAWA, Miyagi-ken (JP)

(21) Appl. No.: 15/347,495

(22) Filed: Nov. 9, 2016

(30) Foreign Application Priority Data
Mar. 16, 2016 (JP) 2016-052984

(51) Int. Cl. G07C 9/00; H04W 12/06; H04L 29/06

(52) U.S. Cl. CPC G07C 9/00309; G07C 9/00007; H04L 63/123; H04W 12/06; G07C 2009/00769

(57) ABSTRACT

Since two pieces of fraudulently acquired authentication information A are transmitted from a transmission device at relatively short time intervals, a time Tp is relatively short, whereas the two pieces of authentication information A are received by a control device at relatively long time intervals, an elapsed time TMAX is relatively long and this relationship is different from that in a case where there is no fraudulent work. Thus, it is possible to accurately determine whether received authentication information is fraudulently acquired information on the basis of a relationship between a code included in the authentication information received in the control device and a code that is being selected in the control device, and a relationship between first time information and second time information included in the authentication information received in the control device.

### CLAIM OF PRIORITY

This application claims the benefit of Japanese Patent Application No. 2016-052984 filed on Mar. 16, 2016, which is hereby incorporated by reference.

### BACKGROUND OF THE INVENTION

1. Field of the Invention

The present invention relates to a communication system in which a control device determines the legitimacy of authentication information transmitted from a transmission device, a control device thereof, and an authentication information determination method, and to, for example, a communication system such as a keyless entry system on which a control device mounted on a vehicle performs control such as in unlocking of a door according to authentication information transmitted from a portable device.

2. Description of the Related Art

A keyless entry system in which a vehicle operation such as locking or unlocking of a door of a vehicle, or startup of an engine is performed on the basis of wireless communication between a vehicle-mounted control device and a portable device is known. Japanese Unexamined Patent Application Publication No. 7-32975 below discloses a keyless entry system in which authentication information (a fixed number and a code number) for lock release is transmitted from a portable device (transmitter) to a vehicle-mounted control device (lock releasing device) using a “rolling code scheme”.

In a rolling code scheme, authentication information is generated using a code that is changed each time authentication information is transmitted. Therefore, even when it was possible to intercept communication between the portable device and the vehicle-mounted control device and acquire the authentication information, it is impossible to pass the authentication of the vehicle-mounted control device using this as it is. That is, since the authentication information obtained through interception of communication has already passed the authentication in the vehicle-mounted control device, the authentication information cannot be used from the next authentication.

However, when the authentication information is acquired through interception of the communication, authentication of the authentication information in the vehicle-mounted control device can be prevented from passing in some cases. For example, there is a method of blocking reception of the authentication information in a vehicle-mounted control device using interference waves simultaneously while intercepting authentication information transmitted from a portable device.

Generally, a reception frequency band of a vehicle-mounted control device is set to be wider than a transmission frequency band of actual authentication information in consideration of individual variations or temperature variation of a product. Therefore, in some cases, only the authentication information can be received using a band pass filter for a narrow band or the like while reception of the authentication information in the vehicle-mounted control device is being blocked by generating interference waves in a reception frequency band and outside of the transmission frequency band. Since the authentication information fraudulently acquired using such a method is regular authentication information that has not yet been received in a vehicle-mounted control device, authentication can be passed by retransmitting the authentication information to the vehicle-mounted control device.

### SUMMARY OF THE INVENTION

The present invention provides a communication system capable of determining that authentication information received in a control device is fraudulently acquired authentication information, a control device therefor, and an authentication information determination method.

A communication system according to a first aspect of the present invention includes a transmission device configured to wirelessly transmit authentication information; and a control device configured to receive the authentication information and determine legitimacy of the received authentication information. The transmission device includes a transmission-side code selection unit configured to sequentially select one code from a predetermined code sequence each time the authentication information is transmitted; a first time information generation unit configured to generate first time information of an elapsed time after the authentication information has been previously transmitted; an authentication information generation unit configured to generate the authentication information according to a code that is being selected in the transmission-side code selection unit and the generated first time information; and a transmission unit configured to transmit the generated authentication information. The control device includes a reception unit configured to receive the authentication information; a determination unit configured to determine legitimacy of the received authentication information; a reception-side code selection unit configured to select a next code in the predetermined code sequence with respect to a code included in the authentication information determined to be legitimate in a case where the received authentication information is determined to be legitimate in the determination unit; and a second time information generation unit configured to generate second time information on an elapsed time after it has been previously determined in the determination unit that the received authentication information satisfies at least some of legitimacy conditions. The determination unit determines whether the received authentication information is fraudulently acquired information on the basis of a relationship between the code included in the received authentication information and the code that is being selected in the reception-side code selection unit, and a relationship between the first time information and the second time information included in the received authentication information.

It may be assumed that two pieces of authentication information transmitted from the transmission device are fraudulently acquired at relatively short time intervals, and the two pieces of authentication information are not received in the control device due to fraudulent work such as using interference waves. In this case, if it is assumed that the two pieces of authentication information are sequentially retransmitted to the control device, a relationship between the code included in the authentication information received in the reception unit and the code that is being selected in the reception-side code selection unit is the same as that in a normal case where there is no fraudulent work using interference waves or the like. However, in a case where a time interval from retransmission of the first authentication information among the two pieces of authentication information to retransmission of the second authentication information is relatively long (for example, a case where fraudulently operating person uses the second authentication information at a time interval such that the use is not noticed by the user), a relationship between the first time information and the second time information included in the received authentication information is different from that in a normal case where there is no process using interference waves or the like. That is, if there is fraudulent work, the two pieces of authentication information are transmitted at relatively short time intervals from the transmission device. Accordingly, since the elapsed time indicated by the first time information is relatively short, whereas the two pieces of authentication information are received by the reception unit at relatively long time intervals, the elapsed time indicated by the second time information is relatively long. In the normal case where there is no fraudulent work, the elapsed time indicated by the first time information and the elapsed time indicated by the second time information are substantially the same. Therefore, according to the communication system according to this embodiment, it is possible to accurately determine whether the received authentication information is fraudulently acquired information on the basis of a relationship between the code included in the authentication information received in the reception unit and the code that is being selected in the reception-side code selection unit, and a relationship between the first time information and the second time information included in the authentication information received in the reception unit.

Preferably, the determination unit determines that the received authentication information is fraudulently acquired information when the code included in the received authentication information matches the code that is being selected in the reception-side code selection unit, and a difference between the elapsed time indicated by the first time information included in the received authentication information and the elapsed time indicated by the second time information deviates from a predetermined allowable range.

According to the above configuration, in a normal case where there is no fraudulent work, the difference between the elapsed time indicated by the first time information included in the received authentication information and the elapsed time indicated by the second time information becomes zero. Therefore, in a case where the difference deviates from the predetermined allowable range, the received authentication information is determined to be fraudulently acquired information.

Preferably, the first time information generation unit starts counting from a predetermined initial value when the authentication information is transmitted in the transmission unit, stops counting when the counted time reaches a predetermined time, and generates the first time information according to a recent counted time in a case where the authentication information is generated in the authentication information generation unit. The second time information generation unit may start counting from the predetermined initial value when it is determined in the determination unit that the received authentication information satisfies at least some of legitimacy conditions, stop counting when the counted time reaches the predetermined time, and generate the second time information according to a recent counted time in a case where the determination is performed in the determination unit.

According to the above configuration, in the first time information generation unit and the second time information generation unit, counting is stopped when a counted time reaches the predetermined time. Thus, power consumption is lower than that in a case where counting is continued.

Preferably, the determination unit may determine that the received authentication information is fraudulently acquired information when the code included in the received authentication information matches the code that is being selected in the reception-side code selection unit, and only any one of a counted time indicated by the first time information included in the received authentication information and a counted time indicated by the second time information reaches the predetermined time.

According to the above configuration, even when the counted time is restricted to being within the predetermined time in the first time information generation unit and the second time information generation unit, it can be determined that the received authentication information is fraudulently acquired information on the basis of a relationship between the counted time indicated by the first time information and the counted time indicated by the second time information.

Preferably, the determination unit may determine that the received authentication information is not legitimate in a case where an order in the predetermined code sequence of the code included in the received authentication information is earlier than that of a code that is being selected in the reception-side code selection unit. The reception-side code selection unit may change a selection target code to a code of which an order in the predetermined code sequence is earlier by a predetermined number than the code that is being selected when it is determined in the determination unit that the received authentication information is fraudulently acquired information.

A plurality of pieces of authentication information transmitted at relatively short intervals from the transmission device are assumed to be fraudulently acquired with fraudulent work for interfering with reception of the control device. Further, a plurality of pieces of fraudulently acquired authentication information are sequentially retransmitted to the control device in a state where the second time information indicates a relatively long elapsed time (for example, a state in which a relatively long time has elapsed from previous reception). Further, it is assumed that the first authentication information among the plurality of fraudulently acquired pieces of authentication information is determined to be fraudulently acquired information in the determination unit. In this case, after the determination of the first authentication information, a selection target code in the reception-side code selection unit is changed to a code of which the order in the predetermined code sequence is earlier by the predetermined number than the code that is being selected.

When the predetermined number is equal to or greater than 2, it is determined that the authentication information is not legitimate since an order in the predetermined code sequence of a code of at least some of the second and subsequent pieces of authentication information among the plurality of fraudulently acquired pieces of authentication information is earlier than that of the code that is being selected in the reception-side code selection unit. Further, it is determined by the determination unit that the authentication information in which the code is the same as the code that is being selected in the reception-side code selection unit among the second and subsequent pieces of authentication information is fraudulently acquired information. After the determination, the same operation as above is repeated since the selection target code in the reception-side code selection unit is changed to a code of which the order is earlier by the predetermined number as described above.

On the other hand, if the predetermined number is 1, the second and subsequent pieces of authentication information are all determined to be fraudulently acquired information in the determination unit. Accordingly, the plurality of pieces of fraudulently acquired authentication information are all determined not to be legitimate in the determination unit.

Preferably, the determination unit may determine that the received authentication information is not legitimate in a case where the code included in the received authentication information is a partial code sequence including, at a head, a code that is being selected in the reception-side code selection unit and does not belong to the partial code sequence having a predetermined length included in the predetermined code sequence. Further, the determination unit may determine last authentication information in N determinations to be legitimate in a case where an arrangement of N codes according to the N determinations matches an arrangement in the predetermined code sequence and an order of the N codes in the predetermined code sequence is earlier than that of the code that is being selected in the reception-side code selection unit in a case where it is determined N times successively that the received authentication information is not legitimate.

According to the above configuration, in a case where an order in the predetermined code sequence of the code that is being selected in the transmission-side code selection unit is earlier than that of the code that is being selected in the reception-side code selection unit, the last authentication information in N transmissions is determined to be legitimate due to N transmissions of the authentication information from the transmission device to the control device. Further, the next code in the predetermined code sequence with respect to the code included in the authentication information determined to be legitimate is newly selected by the reception-side code selection unit.

Preferably, the reception unit may stop reception of the authentication information until a predetermined time elapses after it is determined in the determination unit that the authentication information is fraudulently acquired information.

According to the above configuration, in a case where a plurality of fraudulently acquired consecutive pieces of authentication information are sequentially retransmitted to the control device, the other pieces of authentication information are not received in the reception unit until the predetermined time has elapsed, due to the authentication information at a head being determined to be fraudulently acquired information.

A second aspect of the present invention relates to a control device that receives wirelessly transmitted authentication information and determines legitimacy of the received authentication information. The authentication information is information generated according to one code that is sequentially selected from a predetermined code sequence in each transmission, and first time information on an elapsed time after the authentication information has been previously transmitted. The control device according to the second aspect includes: a reception unit configured to receive the authentication information; a determination unit configured to determine legitimacy of the received authentication information; a reception-side code selection unit configured to select a next code in the predetermined code sequence with respect to a code included in the authentication information determined to be legitimate in a case where the received authentication information is determined to be legitimate in the determination unit; and a second time information generation unit configured to generate second time information on an elapsed time after it is previously determined in the determination unit that the received authentication information satisfies at least some of legitimacy conditions. The determination unit determines legitimacy of the received authentication information on the basis of a relationship between the code included in the received authentication information and the code that is being selected in the reception-side code selection unit, and a relationship between the first time information and the second time information included in the received authentication information.

Preferably, the determination unit may determine that the received authentication information is fraudulently acquired information when the code included in the received authentication information matches code that is being selected in the reception-side code selection unit, and a difference between the elapsed time indicated by the first time information included in the received authentication information and the elapsed time indicated by the second time information deviates from a predetermined allowable range.

Preferably, the first time information may indicate a counted time obtained by performing counting from a predetermined initial value when the authentication information has been previously transmitted. The second time information generation unit may start counting from the predetermined initial value when it is determined in the determination unit that the received authentication information satisfies at least some of legitimacy conditions, stop counting when the counted time reaches the predetermined time, and generate the second time information according to a recent counted time in a case where the determination is performed in the determination unit.

Preferably, the determination unit may determine that the received authentication information is fraudulently acquired information when the code included in the received authentication information matches code that is being selected in the reception-side code selection unit, and only any one of a counted time indicated by the first time information included in the received authentication information and a counted time indicated by the second time information reaches the predetermined time.

Preferably, the determination unit may determine that the received authentication information is not legitimate in a case where an order in the predetermined code sequence of the code included in the received authentication information is earlier than that of a code that is being selected in the reception-side code selection unit. The reception-side code selection unit may change a selection target code to a code of which an order in the predetermined code sequence is earlier by a predetermined number than the code that is being selected when it is determined in the determination unit that the received authentication information is fraudulently acquired information.

Preferably, the reception unit may stop reception of the authentication information until a predetermined time elapses after it is determined in the determination unit that the authentication information is fraudulently acquired information.

A third aspect of the present invention relates to an authentication information determination method in a communication system including a transmission device configured to wirelessly transmit authentication information, and a control device configured to receive the authentication information and determines legitimacy of the received authentication information. The authentication information determination method according to the third aspect includes sequentially selecting, by the transmission device, one code from a predetermined code sequence each time the authentication information is transmitted; generating, by the transmission device, first time information on elapsed time after the authentication information has been previously transmitted; generating, by the transmission device, the authentication information according to the code that is being selected and the generated first time information; transmitting, by the transmission device, the generated authentication information; receiving, by the control device, the authentication information; determining, by the control device, legitimacy of the received authentication information; selecting, by the control device, a next code in the predetermined code sequence with respect to a code included in the authentication information determined to be legitimate in a case where the received authentication information is determined to be legitimate; and generating, by the control device, second time information on an elapsed time after it is previously determined in the determination unit that the received authentication information satisfies at least some of legitimacy conditions. Determining, by the control device, legitimacy of the authentication information includes determining whether the authentication information is fraudulently acquired information on the basis of a relationship between the code included in the authentication information received by the control device and the code that is being selected in the control device, and a relationship between the first time information included in the authentication information received by the control device and the second time information generated by the control device.

According to the present invention, it is possible to determine that authentication information received in the control device is fraudulently acquired authentication information.

### BRIEF DESCRIPTION OF THE DRAWINGS

FIG. 1 is a first diagram illustrating an example of a configuration of a communication system according to an embodiment of the present invention.

FIG. 2 is a second diagram illustrating an example of a configuration of a communication system according to an embodiment of the present invention.

FIG. 3 is a diagram illustrating an operation example in a case where normal communication is performed between a transmission device and a control device, and illustrating a case where a code of the transmission device matches a code of the control device.

FIG. 4 is a diagram illustrating an operation example in a case where normal communication is performed between a transmission device and a control device, and illustrating a case where a code of the transmission device progresses slightly ahead of a code of the control device.

FIG. 5 is a diagram illustrating an operation example in a case where normal communication is performed between a transmission device and a control device, and illustrating a case where a code of the transmission device progresses greatly ahead of a code of the control device.

FIG. 6 is a diagram illustrating an example in which interception and reception interference of authentication information are performed by a fraudulent unlock device.

FIG. 7 is a diagram illustrating a comparative example illustrating an attack of a fraudulent unlock device.

FIG. 8 is a diagram illustrating an example of an operation in a case where authentication information fraudulently acquired by a fraudulent unlock device is used in a communication system according to an embodiment of the present invention.

FIG. 9 is a diagram illustrating an example of an operation in a case where fraudulently acquired authentication information is continuously transmitted.

FIG. 10 is a diagram illustrating a modification example of the operation in a case where fraudulently acquired authentication information is continuously transmitted.

FIG. 11 is a diagram illustrating another modification example of the operation in a case where fraudulently acquired authentication information is continuously transmitted.

FIG. 12 is a diagram illustrating still another modification example of the operation in a case where fraudulently acquired authentication information is continuously transmitted.

### DESCRIPTION OF THE PREFERRED EMBODIMENTS

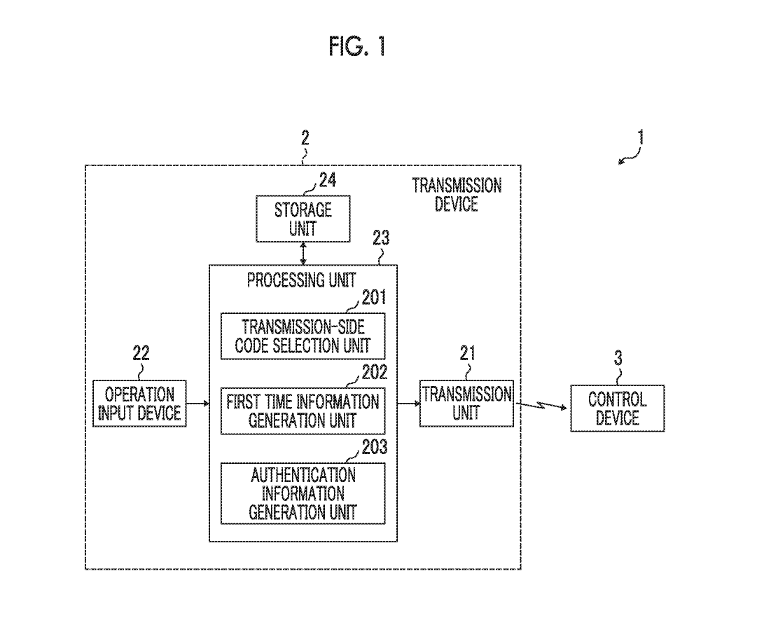

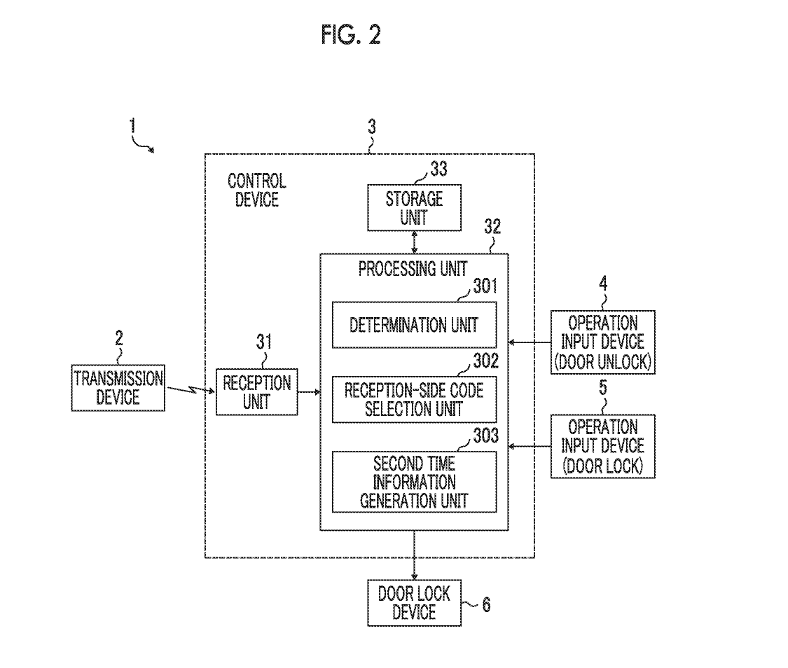

FIGS. 1 and 2 are diagrams illustrating an example of a configuration of a communication system 1 according to an embodiment of the present invention. The communication system 1 illustrated in FIG. 1 is, for example, a keyless entry system that controls release of doors in a vehicle through wireless remote control, and includes a transmission device 2 that can be carried by a user as a portable device, and a control device 3 mounted on the vehicle or the like.

### Transmission Device 2

In the example of FIG. 1, the transmission device 2 includes a transmission unit 21, an operation input device 22, a processing unit 23, and a storage unit 24.

The transmission unit 21 wirelessly transmits authentication information generated in the processing unit 23 to the control device 3. That is, the transmission unit 21 performs predetermined signal processing such as coding, modulation, and amplification on data including the authentication information generated in the processing unit 23 to generate a transmission signal of a predetermined communication scheme, and transmits the transmission signal as a radio signal from an antenna (not illustrated).

The operation input device 22 is a device that generates a signal according to a predetermined operation of the user and is configured with, for example, a button or a touch sensor.

The processing unit 23 is a circuit that performs overall control of the transmission device 2 and is configured, for example, with a computer (for example, a microprocessor) that executes instructions on the basis of a program stored in the storage unit 24, or a dedicated logic circuit (ASIC).

When a signal according to a predetermined operation for instructing transmission of the authentication information is generated in the operation input device 22, the processing unit 23 generates the authentication information on the basis of the data stored in the storage unit 24, and transmits the authentication information as a radio signal from the transmission unit 21.

The processing unit 23 is a processing block that executes a predetermined process, and includes a transmission-side code selection unit 201, a first time information generation unit 202, and an authentication information generation unit 203.

The transmission-side code selection unit 201 sequentially selects one code from a predetermined code sequence each time the authentication information is transmitted from the transmission unit 21. The “Predetermined code sequence” includes a plurality of codes arranged in determined order. It is preferable for all the plurality of codes to be different codes. In one example, the “predetermined code sequence” is a sequence of numerical values that are sequentially changed according to a predetermined rule (for example, are incremented by 1), and each numerical value indicates one code. In another example, the “predetermined code sequence” may be a sequence of numerical values that have no regularity. The transmission-side code selection unit 201 selects the code one by one from the “predetermined code sequence” in each transmission of the authentication information according to an order of the sequence of the codes in the “predetermined code sequence”.

In the following description, for example, it is assumed that each code of the “predetermined code sequence” is a natural numerical value, and each code has a value greater by 1 than that of a code having an order earlier by 1. That is, the “predetermined code sequence” has a code value increased by 1 when the order goes ahead by 1. The transmission-side code selection unit 201 can select the code in any order in the “predetermined code sequence” by adding or subtracting any numerical value to or from the code that is being selected. For example, in a case where the code that is being selected is “K”, if the authentication information is transmitted once from the transmission unit 21, the transmission-side code selection unit 201 newly selects “K+1” obtained by adding 1 to the code “K” that is being selected.

The first time information generation unit 202 generates first time information on an elapsed time after previous transmission of the authentication information from the transmission unit 21. For example, the first time information generation unit 202 includes a timer, and when the authentication information is transmitted in the transmission unit 21, counting is started from a predetermined initial value by the timer. When the counted time of the timer reaches a predetermined maximum time (for example, 1 minute), the first time information generation unit 202 stops a counting operation of the timer. In a case where the authentication information is generated in the authentication information generation unit 203 to be described below, the first time information generation unit 202 generates first time information according to a recent counted time obtained by the counting operation of the timer as first time information used to generate the authentication information. In a case where the counted time reaches the above-described maximum time, the elapsed time from the previous transmission indicated by the first time information is at least a predetermined time, and a specific time is unclear.

The authentication information generation unit 203 generates authentication information according to the code that is being selected in the transmission-side code selection unit 201 and the first time information generated by the first time information generation unit 202. For example, in addition to the code that is being selected or the first time information described above, identification information for identifying the control device 3 that is a transmission destination from other devices or identification information for identifying the transmission device 2 itself from other devices is included in the authentication information. The authentication information generation unit 203 generates authentication information that includes such information and is encrypted.

The storage unit 24 is, for example, a device that stores a computer program in the processing unit 23, data prepared for processing (for example, identification information of a device included in the authentication information, and key information for encryption of the authentication information), and data temporarily stored in a process (for example, a code that is being selected in the transmission-side code selection unit 201, and first time information generated by the first time information generation unit 202), and includes a RAM, a non-volatile memory, or a hard disk. The program or the data stored in the storage unit 24 may be downloaded from an external device via an interface device (not illustrated) or may be read from a non-transitory recording medium such as an optical disk or a USB memory.

### Control Device 3

The control device 3 is a device that controls various devices in the vehicle, and controls a door lock device 6 that locks and unlocks the doors in the example of FIG. 2. When the control device 3 receives the authentication information from the transmission device 2, the control device 3 determines legitimacy of the authentication information, and in a case where the control device 3 determines that the authentication information is legitimate, the control device 3 controls the door lock device 6 so that the door lock device 6 performs the unlocking or locking of the door. Further, the control device 3 controls the door lock device 6 so that the door lock device 6 performs unlocking and locking of the door according to an operation of the operation input devices 4 and 5 such as a switch, a button, or a touch sensor provided in the vehicle.

In the example of FIG. 2, the control device 3 includes a reception unit 31, a processing unit 32, and a storage unit 33.

The reception unit 31 receives the authentication information that is wirelessly transmitted from the transmission device 2. That is, the reception unit 31 performs predetermined signal processing such as amplification, demodulation, and decoding on a radio signal received in an antenna (not illustrated) to generate reception data, and outputs the reception data to the processing unit 32.

The processing unit 32 is a circuit that performs overall control of the control device 3 and includes, for example, a computer (for example, a microprocessor) that executes an instruction on the basis of a program stored in the storage unit 33 or a dedicated logic circuit (for example, ASIC).

The processing unit 32 is a processing block that executes a predetermined process, and includes a determination unit 301, a reception-side code selection unit 302, and a second time information generation unit 303.

In a case where the authentication information received in the reception unit 31 is determined to be legitimate in the determination unit 301 to be described below, the reception-side code selection unit 302 selects a next code in the “predetermined code sequence” with respect to code included in the authentication information determined to be legitimate. The “predetermined code sequence” of the reception-side code selection unit 302 is the same as the transmission-side code selection unit 201. For example, in a case where the “predetermined code sequence” is a sequence of numerical values that are progressive by 1 as “1”, “2”, “3”, . . . and the code included in the authentication information determined to be legitimate in the determination unit 301 is “K”, the reception-side code selection unit 302 newly selects “K+1” obtained by adding 1 to the code.

The second time information generation unit 303 generates second time information on an elapsed time after it is previously determined in the determination unit 301 that the authentication information received by the reception unit 31 satisfies at least some of legitimacy conditions. In the following description, for example, the second time information generation unit 303 is assumed to generate the second time information on the elapsed time after it is previously determined that the authentication information received by the reception unit 31 satisfies all of the legitimacy conditions and is legitimate authentication information. As another example of the present invention, the second time information generation unit 303 may generate the second time information on the elapsed time after it is previously determined in the determination unit 301 that the authentication information satisfies some of the legitimacy conditions (for example, only a “first condition” to be described below or only the “first condition” and a “second condition”).

The second time information generation unit 303 includes, for example, a timer. If the determination unit 301 determines that the authentication information received by the reception unit 31 satisfies at least some of legitimacy conditions, the second time information generation unit 303 starts counting from a predetermined initial value (the same initial value as in the first time information generation unit 202) using the timer. The second time information generation unit 303 stops a counting operation of the timer when a counted time of the timer reaches a predetermined maximum time (the same maximum time as in the first time information generation unit 202). When a new determination is performed by the determination unit 301, the second time information generation unit 303 generates second time information according to a recent counted time obtained by the counting operation of the timer as second time information used in the determination. In a case where the counted time has reached the above-described maximum time, an elapsed time from the previous determination indicated by the second time information is at least a predetermined time, and a specific time is unclear.

When the authentication information is normally received in the reception unit 31, the determination unit 301 decodes respective encrypted pieces of information (for example, transmission source identification information, transmission destination identification information, the code selected in the transmission-side code selection unit 201, and the first time information generated by the first time information generation unit 202) included in the received authentication information. The determination unit 301 determines the legitimacy of the received authentication information on the basis of the decoded information, the code that is being selected in the reception-side code selection unit 302, and the second time information generated by the second time information generation unit 303.

The determination unit 301 collates the identification information (transmission source identification information and the own device identification information) included in the received authentication information with predetermined identification information stored in the storage unit 33. The determination unit 301 sets match of both on the basis of the collating, as one of conditions of the legitimacy of the authentication information. Hereinafter, this is referred to as a “first condition”.

Further, the determination unit 301 checks whether the code included in the authentication information received by the reception unit 31 and the code that is being selected in the reception-side code selection unit 302 satisfies a predetermined relationship. The determination unit 301 sets that the code included in the authentication information and the code that is being selected satisfying the predetermined relationship on the basis of this check, as one of conditions of the legitimacy of the authentication information. Hereinafter, this is referred to as a “second condition”.

For example, the determination unit 301 checks whether the code included in the received authentication information belongs to a partial code sequence having a predetermined length included in the “predetermined code sequence”. A code at a head of the partial code sequence is a code that is being selected in the reception-side code selection unit 302. Specifically, for example, when the code that is being selected in the reception-side code selection unit 302 is “K” and the partial code sequence is “K”, “K+1”, . . . , a “K−α”, and the code included in the received authentication information is “K+β” (0≦β≦αα), the determination unit 301 determines that the “second condition” is satisfied.

In a case where the code included in the received authentication information matches the code progressing ahead of the code at a head of the partial code sequence (0<β≦α in the above example), the code that is being selected in the transmission-side code selection unit 201 progresses ahead of the code that is being selected in the reception-side code selection unit 302, for example, due to transmission of the authentication information from the transmission device 2 at a place remote from the control device 3. Hereinafter, this state is referred to as a “code progressive state”. Further, a state in which the code included in the received authentication information matches the code at the head of the partial code sequence is referred to as a “code match state”.

In a case where the “first condition” or the “second condition” is not satisfied, the determination unit 301 determines that the authentication information is not legitimate.

In a case where the “first condition” is satisfied and the “second condition” is satisfied in a code progressive state, the determination unit 301 determines that the authentication information is legitimate.

In a case where the “first condition” is satisfied and the “second condition” is satisfied in a code matching state, the determination unit 301 further checks whether the authentication information is fraudulently acquired information, as will be described next.

The determination unit 301 determines whether the received authentication information is fraudulently acquired information on the basis of a relationship between the code included in the authentication information received by the reception unit 31 and the code that is being selected in the reception-side code selection unit 302 and a relationship between the first time information included in the received authentication information and the second time information generated by the second time information generation unit 303.

For example, the determination unit 301 determines that the received authentication information is fraudulently acquired information in a case where the code included in the authentication information received by the reception unit 31 matches the code that is being selected in the reception-side code selection unit 302 (code match state), and a difference between the elapsed time indicated by the first time information included in the received authentication information and the elapsed time indicated by the second time information deviates from a predetermined allowable range.

The determination unit 301 determines that the received authentication information is fraudulently acquired information in the code matching state, and in a case where only one of the counted time of the timer indicated by the first time information and the counted time of the timer indicated by the second time information included in the received authentication information reaches the predetermined maximum time (that is, one of the counted times is equal to or longer than the maximum time and the other is shorter than the maximum time).

The determination unit 301 determines the authentication information to be legitimate in a case where the “first condition” is satisfied, the “second condition” is satisfied in the code match state, and the authentication information is not fraudulently acquired information as a result of the above-described test.

In normal use of the transmission device 2, there may be a code progressive state in which the order in the “predetermined code sequence” is earlier such that the “first condition” is satisfied, but the “second condition” is not satisfied. For example, in a case where a transmission operation of the transmission device 2 is repeated multiple times at a place where radio waves do not reach the control device 3, such a state is obtained. In a case where a certain condition to be described below is satisfied, the determination unit 301 determines the authentication information to be legitimate even in an excessive code progressive state in which the “second condition” is not satisfied.

That is, in a case where the determination unit 301 determines N times successively that the authentication information is not legitimate due to the “first condition” being satisfied and the “second condition” being not satisfied in a code progressive state, if an arrangement of N codes according to the N determinations matches an arrangement in the “predetermined code sequence”, the determination unit 301 re-determines that last authentication information in the N determinations is legitimate.

For example, it is assumed that the code that is being selected in the reception-side code selection unit 302 is “K”, codes of the authentication information received N times successively are “L”, “L+1”, . . . , “L+N−1”, and “L” progresses ahead of the partial code sequence (K, K+1, . . . , K+α) including “K” at a head (K+α<L). In this case, the determination unit 301 re-determines that the authentication information received last among the N times is legitimate. The reception-side code selection unit 302 selects “L+N” next to “L+N−1” determined to be legitimate by the determination unit 301 as a new code. Therefore, the code “L+N” of the authentication information transmitted next from the transmission device 2 matches a code “L+N” newly selected by the reception-side code selection unit 302, and this authentication information satisfies the “second condition”.

The storage unit 33 is, for example, a device that stores a computer program in the processing unit 32, data prepared for processing (for example, identification information of a device used for collation of the authentication information, and key information for encryption of the authentication information), and data temporarily stored in a process (for example, a code that is being selected in the reception-side code selection unit 302, and second time information generated by the second time information generation unit 303), and includes a RAM, a non-volatile memory, or a hard disk. The program or the data stored in the storage unit 33 may be downloaded from an external device via an interface device (not illustrated) or may be read from a non-transitory recording medium such as an optical disk or a USB memory.

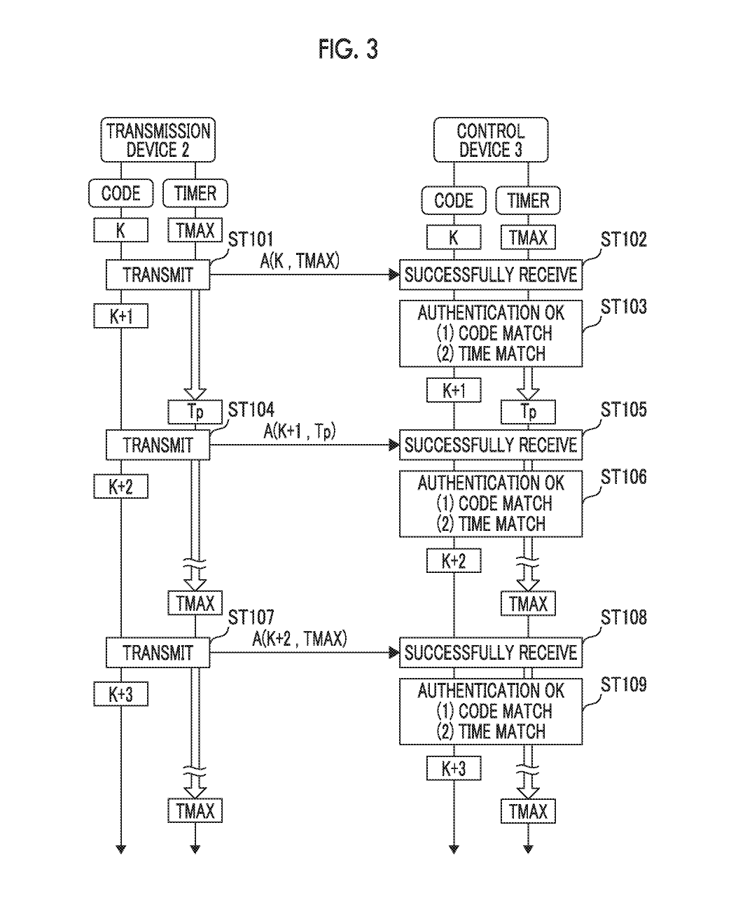

A method of determining the authentication information in the communication system 1 having the above configuration will be described herein with reference to FIGS. 3 to 8.

First, an operation example in a case where normal communication is performed between the transmission device 2 and the control device 3 will be described.

FIG. 3 illustrates an example of an operation in a case where a code of the transmission device 2 matches a code of the control device 3. In each drawing subsequent to FIG. 3, reference sign “A” indicates authentication information. Further, a first reference sign in parentheses added to reference sign “A” indicates the code included in the authentication information, and a second reference sign in the parentheses indicates the elapsed time of the first time information included in the authentication information.

In the following description of an example of an operation, it is assumed that the identification information included in the authentication information generated by the transmission device 2 matches identification information held in the control device 3, unless otherwise specified. That is, the above-described “first condition” is assumed to be always satisfied at the time of the determination of the determination unit 301.

First, both of the transmission-side code selection unit 201 of the transmission device 2 and the reception-side code selection unit 302 of the control device 3 select the code “K”. Further, both of the first time information generated by the first time information generation unit 202 of the transmission device 2 and the second time information generated by the second time information generation unit 303 of the control device 3 indicate the maximum time “TMAX” since the predetermined time has elapsed from previous transmission. In this state, if the transmission device 2 transmits the authentication information A, the code “K” and the first time information “TMAX” are included in the authentication information A (ST101). Due to the transmission of the authentication information A, the transmission-side code selection unit 201 selects the next code “K+1”, and the first time information generation unit 202 starts counting from the initial value.

The control device 3 normally receives the authentication information A (ST102). The code “K” included in the authentication information A matches the code “K” that is being selected in the reception-side code selection unit 302 (second condition). Further, the first time information “TMAX” included in the received authentication information A matches the second time information “TMAX”. Therefore, the determination unit 301 determines the received authentication information A to be legitimate (ST103). When the authentication information A is determined as legitimate, the reception-side code selection unit 302 selects the code “K+1” next to the code “K” included in the authentication information A, and the second time information generation unit 303 starts counting from the initial value.

When the elapsed time of the first time information is “Tp”, the transmission device 2 transmits the authentication information A (ST104). The code “K+1” and the first time information “Tp” are included in this authentication information A. Due to the transmission of the authentication information A, the transmission-side code selection unit 201 selects the next code “K+1”, and the first time information generation unit 202 starts counting from the initial value.

The control device 3 normally receives the authentication information A (ST105). The code “K+1” included in the authentication information A matches the code “K+1” that is being selected in the reception-side code selection unit 302, and the first time information “Tp” included in the authentication information A is substantially equal to the second time information “Tp”. Therefore, the determination unit 301 determines the received authentication information A to be legitimate (ST106). When the authentication information A is determined to be legitimate, the reception-side code selection unit 302 selects the code “K+2” next to the code “K+1” included in the authentication information A, and the second time information generation unit 303 starts counting from the initial value.

When the elapsed time of the first time information is equal to or greater than “TMAX”, the transmission device 2 transmits the authentication information A (ST107). The code “K+2” and the first time information “TMAX” are included in this authentication information A. Due to the transmission of the authentication information A, the transmission-side code selection unit 201 selects the next code “K+3”, and the first time information generation unit 202 starts counting from the initial value.

The control device 3 normally receives the authentication information A (ST108). The code “K+2” included in the authentication information A matches the code “K+2” that is being selected in the reception-side code selection unit 302, and the first time information “TMAX” included in the authentication information A matches the second time information “TMAX’. Therefore, the determination unit 301 determines the received authentication information A to be legitimate (ST109). When the authentication information A is determined to be legitimate, the reception-side code selection unit 302 selects the code “K+3” next to the code “K+2” included in the authentication information A, and the second time information generation unit 303 starts counting from the initial value.

The same operation is repeated.

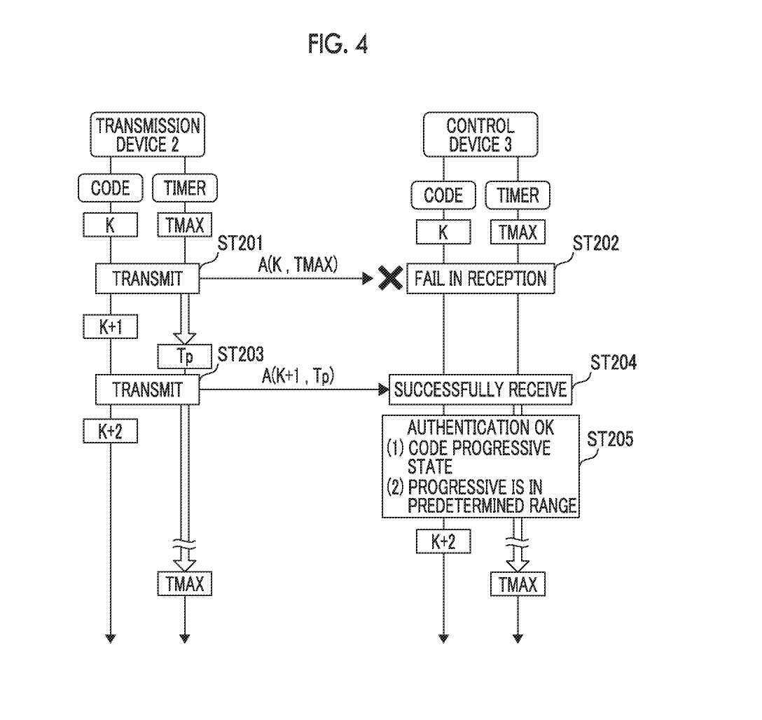

FIG. 4 illustrates an example of an operation in a case where the code of the transmission device 2 progresses slightly ahead of the code of the control device 3.

First, both of the transmission-side code selection unit 201 and the reception-side code selection unit 302 select the code “K”, and both of the first time information of the first time information generation unit 202 and the second time information of the second time information generation unit 303 indicate a maximum time “TMAX”. In this state, the transmission device 2 transmits the authentication information A(K, TMAX) (ST201). Through this transmission, the transmission-side code selection unit 201 selects the next code “K+1”, and the first time information generation unit 202 starts counting from the initial value.

The control device 3 fails in reception of the authentication information A(K, TMAX) transmitted from the transmission device 2 (ST202). For example, if the transmission device 2 has performed the transmission at a place remote from the control device 3, failure of the reception is caused due to low strength of radio waves.

When the elapsed time of the first time information is “Tp”, the transmission device 2 transmits the authentication information A again (ST203). The code “K+1” and the first time information “Tp” are included in the authentication information A. Through this transmission, the transmission-side code selection unit 201 selects the next code “K+2”.

The control device 3 successfully receives this authentication information A (ST204). The code “K+1” included in the received authentication information A progresses ahead by 1 of the code “K” that is being selected in the reception-side code selection unit 302, but belongs to a partial code sequence having a predetermined length, and a progressive state is within a range of the partial code sequence. Therefore, the determination unit 301 determines that the received authentication information A is legitimate (ST205). When the authentication information A is determined to be legitimate, the reception-side code selection unit 302 selects code “K+2” next to “K+1” included in the authentication information A. As a result, the code of the control device 3 matches the code of the transmission device 2.

Thus, in a case where the code included in the authentication information A progresses slightly ahead of the code that is being selected in the reception-side code selection unit 302 (a case where the code belongs to the partial code sequence having a predetermined length), the determination unit 301 determines the authentication information to be legitimate even when the first time information and the second time information included in the authentication information do not match.

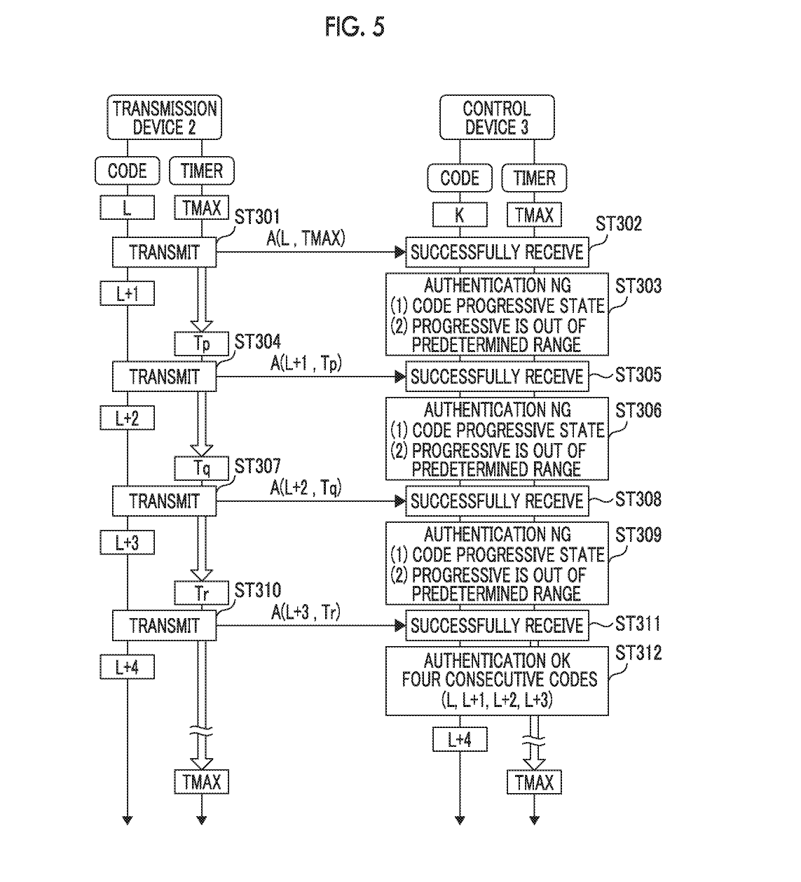

FIG. 5 shows an example of an operation in a case where the code of the transmission device 2 progresses greatly ahead of the code of the control device 3.

First, the transmission-side code selection unit 201 selects the code “L”, and the reception-side code selection unit 302 selects the code “K”. “L” progresses ahead of the “K”, and a difference therebetween is greater than the range of the partial code sequence (L>K+α). In this state, the transmission device 2 transmits the authentication information A(L, TMAX) (ST301). Through this transmission, the transmission-side code selection unit 201 selects the next code “L+1”, and the first time information generation unit 202 starts counting from the initial value.

The control device 3 normally receives the authentication information A(L, TMAX) (ST302). Since the code “L” included in the authentication information A progresses ahead of the partial code sequence that is a head of the code “K” that is being selected in the reception-side code selection unit 302, the determination unit 301 determines the authentication information A not to be legitimate (ST303).

Through a similar operation, the transmission device 2 transmits authentication information A(L+1, Tp) and A (L+2, Tq) (ST304 and ST307), and the control device 3 successfully receives the authentication information (ST305 and ST 308), but the determination unit 301 determines the authentication information not to be legitimate since both of pieces of the authentication information include the code progressing ahead of the partial code sequence (ST306 and ST309).

Further, the transmission device 2 transmits the authentication information A(L+3, Tr) (ST310). Through this transmission, the transmission-side code selection unit 201 selects the next code “L+4”. The control device 3 normally receives authentication information A(L+3, Tr) (ST311). Since the code “L+3” included in the authentication information A(L+3, Tr) progresses ahead of the partial code sequence as described above, the determination unit 301 determines the authentication information A(L+3, Tr) not to be legitimate.

However, until now, it is determined continuously four times that the authentication information is not legitimate (ST303, ST306, ST306, and ST312), an arrangement (L, L+1, L+2, and L+3) of four codes according to the four determinations matches an arrangement in the “predetermined code sequence”, and an order of the four codes in the “predetermined code sequence” is earlier than the code “K” that is being selected in the reception-side code selection unit 302. In this case, the determination unit 301 re-determines the last authentication information A(L+3, Tr) in the four determinations to be legitimate (ST312). Accordingly, the reception-side code selection unit 302 newly selects of the code “L+4” next to the code “L+3” included in the last authentication information A(L+3, Tr). As a result, the code of the transmission device 2 matches the code of the control device 3.

Next, an operation in a case where an attack that attempts to pass authentication of the control device 3 using fraudulently acquired authentication information is performed will be described.

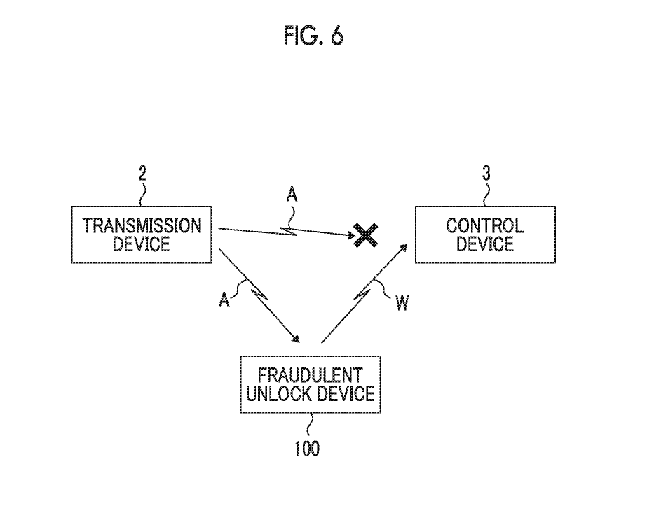

FIG. 6 is a diagram illustrating an example in which interception and reception interference of authentication information are performed by the fraudulent unlock device 100. The fraudulent unlock device 100 is disposed in a position in which the fraudulent unlock device 100 is able to intercept the authentication information A transmitted from the transmission device 2 and is able to transmit interference waves W to the control device 3. When the fraudulent unlock device 100 detects that the authentication information A is transmitted from the transmission device 2, the fraudulent unlock device 100 outputs the interference waves W to the control device 3 to block the authentication information A being received by the control device 3, removes the interference waves W using a band pass filter or the like to acquire the authentication information A.

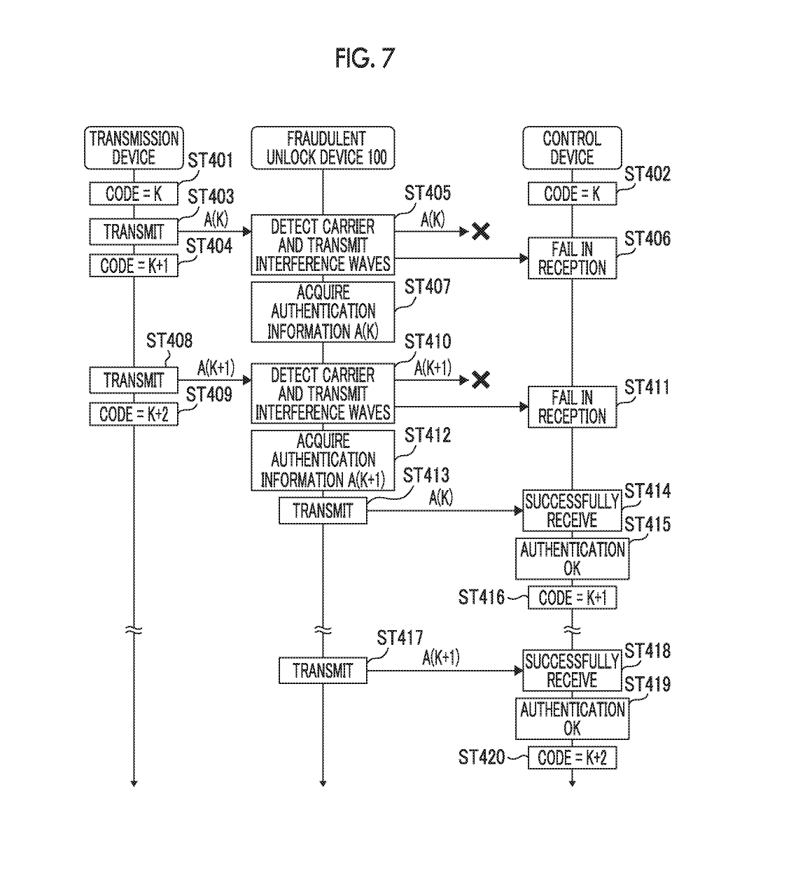

FIG. 7 is a diagram illustrating a comparative example illustrating an attack of the fraudulent unlock device 100.

First, both of the transmission device and the control device select the code “K” (ST401 and ST402). When the transmission device transmits the authentication information A including the code “K”, the transmission device selects the next code “K+1” (ST403 and ST404). When the fraudulent unlock device 100 detects that the authentication information A is transmitted by the transmission device, using a carrier or the like of a transmission signal, the fraudulent unlock device 100 outputs interference waves W toward the control device (ST405). As a result, the control device fails in reception of the authentication information A (ST406). The fraudulent unlock device 100 removes the interference waves W using a band pass filter or the like to acquire the authentication information A (ST407).

When the control device fails in reception of the authentication information A, predetermined control (for example, unlocking of a door) is not performed in the control device. Therefore, a transmission operation is performed by the user again, and the authentication information A is retransmitted from the transmission device (ST408). In this case, the code included in the authentication information A is “K+1”. The fraudulent unlock device 100 also interferes with the reception of the authentication information A (ST410 and ST411) to acquire the authentication information A including the code “K+1” (ST412). When the fraudulent unlock device 100 acquires the authentication information A, the fraudulent unlock device 100 immediately retransmits the authentication information A acquired in step ST407 to the control device (ST413). In this case, since the fraudulent unlock device 100 does not output the interference waves, the control device successfully receives the authentication information A (ST414). The authentication information A acquired in step ST407 includes the code “K” and the code matches the code “K” that is being selected by the control device, the control device determines that this authentication information A to be legitimate (ST415). Accordingly, the control device executes predetermined control such as door unlocking. The control device selects the next code “K+1” by authenticating the authentication information A including the code “K” (ST416). The user misunderstands that control such as door unlocking has been executed by an operation in step ST408 and does not notice presence of fraudulent unlock device 100.

Thereafter, when time has elapsed and there is no user, the fraudulent unlock device 100 retransmits the authentication information A acquired in step ST412 to the control device (ST417). When the control device receives the retransmitted authentication information A (ST418), the control device determines that the authentication information A to be legitimate since the code “K+1” included in the authentication information A matches the code that is being selected (ST419).

Thus, the fraudulent unlock device 100 successfully passes the authentication of the control device using the fraudulently acquired authentication information A.

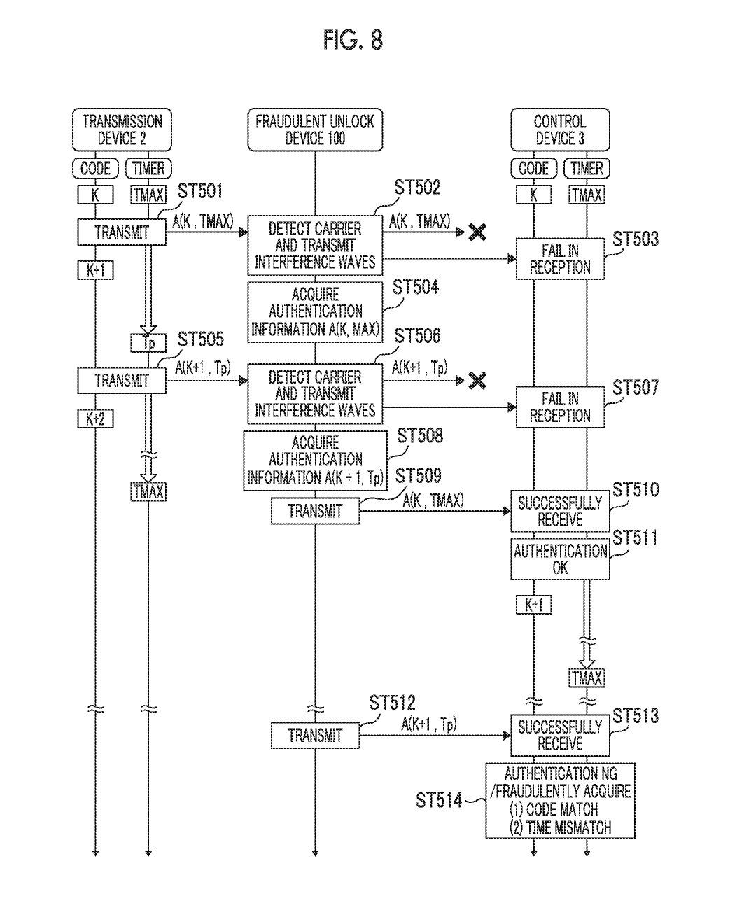

FIG. 8 is a diagram illustrating an example of an operation in a case where the authentication information fraudulently acquired by the fraudulent unlock device 100 is used in the communication system 1 according to an embodiment of the present invention.

First, both the transmission-side code selection unit 201 and the reception-side code selection unit 302 select the code “K”, and both the first time information of the first time information generation unit 202 and the first time information of the second time information generation unit 303 indicate the maximum time “TMAX”. In this state, the transmission device 2 transmits the authentication information A(K, TMAX) (ST501). Through this transmission, the transmission-side code selection unit 201 selects the next code “K+1”, and the first time information generation unit 202 starts counting from the initial value.

When the fraudulent unlock device 100 detects that the authentication information is transmitted from the transmission device 2 using a carrier or the like of the transmission signal, the fraudulent unlock device 100 outputs interference waves W toward the control device 3 (ST502). Accordingly, the control device 3 fails reception of the authentication information A(K, TMAX) (ST503). The fraudulent unlock device 100 removes the interference waves W using a band pass filter or the like, and acquires the authentication information A(K, TMAX) (ST504).

When the control device fails in reception of the authentication information A, the authentication information A(K+1, Tp) is transmitted again from the transmission device at a timing when the elapsed time of the first time information is “Tp” by a re-transmission operation of the user (ST505). Through this transmission, the transmission-side code selection unit 201 selects the next code “K+2”, and the first time information generation unit 202 starts counting from the initial value.

The fraudulent unlock device 100 also interferes with the transmission of the authentication information A(K+1, Tp) (ST506 and ST507), and acquires the authentication information A(K+1, Tp) that the control device 3 has been unable to receive (ST508). When the fraudulent unlock device 100 acquires the authentication information A(K+1, Tp), the fraudulent unlock device 100 immediately retransmits the authentication information A(K, TMAX) acquired in step ST504 to the control device (ST 509). At this time, since the fraudulent unlock device 100 does not output the interference waves, the control device successfully receives the authentication information A(K, TMAX) (ST510). Since the code “K” included in the authentication information A(K, TMAX) matches the code that is being selected in the control device and the first time information “TMAX” included in the authentication information A(K, TMAX) matches the second time information generated by the second time information generation unit 303, the determination unit 301 determines that the authentication information A(K, TMAX) is legitimate (ST511). When the authentication information A(K, TMAX) is determined to be legitimate, the reception-side code selection unit 302 selects the code “K+1” next to the code “K” included in the authentication information A, and the second time information generation unit 303 starts counting from the initial value.

Then, the fraudulent unlock device 100 retransmits the authentication information A(K+1, Tp) acquired in step ST508 to the control device 3 (ST512). In this case, in the second time information generation unit 303 of the control device 3, the second time information is a maximum time “TMAX”. The control device 3 receives the authentication information A(K+1, Tp) (ST513). The code “K+1” included in this authentication information A(K+1, Tp) matches the code that is being selected in the reception-side code selection unit 302. However, the first time information “Tp” included in the authentication information A(K+1, Tp) is different from the second time information “TMAX” generated in the second time information generation unit 303. That is, since the maximum time “TMAX” is set to be sufficiently longer than a general time until a transmission operation is performed again by the user, “TMAX” is sufficiently longer than “Tp”. Therefore, the determination unit 301 determines the received authentication information A(K+1, Tp) is fraudulently acquired information (ST514).

As described above, in a case where two pieces of authentication information transmitted from the transmission device 2 are fraudulently acquired at relatively short time intervals, and the two pieces of authentication information are not received by the control device 3 due to fraudulent work such as using interference waves, if the two pieces of authentication information are sequentially retransmitted to the control device 3, a relationship between the code included in the authentication information received by the reception unit 31 and the code that is being selected in the reception-side code selection unit 302 becomes the same as in a normal case where there is no fraudulent work using interference waves or the like (FIG. 7).

However, in a case where a time interval from retransmission of the first authentication information among the two pieces of authentication information to retransmission of the second authentication information is relatively long, a relationship between the first time information and the second time information included in the authentication information received in the reception unit 31 is different from that in a normal case where there is no work using interference waves or the like. That is, if there is fraudulent work, the two pieces of authentication information are transmitted at relatively short time intervals from the transmission device 2. Accordingly, since the elapsed time indicated by the first time information is relatively short, whereas the two pieces of authentication information are received by the reception unit 31 at relatively long time intervals, the elapsed time indicated by the second time information is relatively long. In the normal case where there is no fraudulent work, the elapsed time indicated by the first time information and the elapsed time indicated by the second time information are substantially the same. Therefore, according to the communication system 1 according to this embodiment, it is possible to accurately determine whether the received authentication information is fraudulently acquired information on the basis of a relationship between the code included in the authentication information received in the reception unit 31 and the code that is being selected in the reception-side code selection unit 302, and a relationship between the first time information and the second time information included in the authentication information received in the reception unit 31.

Further, according to the communication system 1 according to this embodiment, in the first time information generation unit 202 and the second time information generation unit 303, counting is stopped when the counted time reaches a predetermined maximum time. Accordingly, it is possible to effectively reduce power consumption as compared with a case where counting is continuously performed.

Next, a modification example of the communication system 1 according to this embodiment described above will be described.

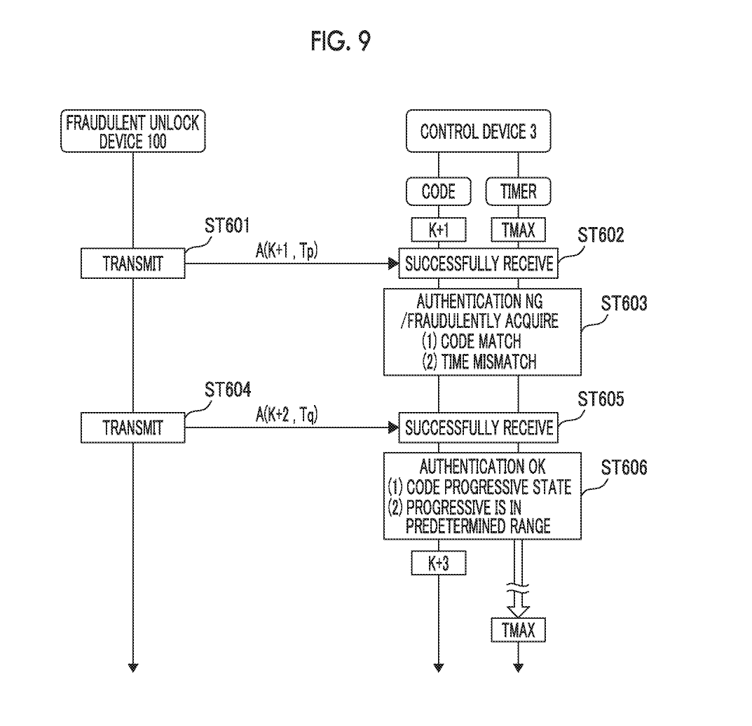

FIG. 9 is a diagram illustrating an example of an operation in a case where fraudulently acquired pieces of authentication information are continuously transmitted.

In this example, first, a code that is being selected by the reception-side code selection unit 302 is “K+1”, and the second time information generated in the second time information generation unit 303 is a maximum time “TMAX”. In this state, the authentication information A(K+1, Tp) is transmitted from the fraudulent unlock device 100, and is received by the reception unit 31 (ST601 and ST602). The code “K+1” included in the authentication information A(K+1, Tp) matches the code that is being selected in the reception-side code selection unit 302, but the first time information “Tp” included in the authentication information A(K+1, Tp) is different from the second time information “TMAX” generated in the second time information generation unit 303. Therefore, the determination unit 301 determines that the received authentication information A(K+1, Tp) is fraudulently acquired information (ST603). This operation is the same as step ST514 in the flow diagram illustrated in FIG. 8.

In the example of FIG. 9, in this state, the authentication information A(K+2, Tq) is transmitted from the fraudulent unlock device 100 and received by the control device 3 (ST604 and ST605). In this case, the code “K+2” included in the received authentication information A progresses ahead by 1 of the code “K+1” that is being selected in the reception-side code selection unit 302, but belongs to a partial code sequence having a predetermined length, and a progressive state is within a range of the partial code sequence. Therefore, the determination unit 301 determines that the received authentication information A is legitimate (ST606). This operation is the same as in step ST205 in FIG. 4. Therefore, in a case where the pieces of fraudulently acquired authentication information are continuously transmitted, the second authentication information pass the authentication.

Therefore, in this modification example, in a case where the authentication information is determined to be fraudulently acquired, the codes are progressive in the reception-side code selection unit 302 of the control device 3. That is, in a case where it is determined in the determination unit 301 that the received authentication information is fraudulently acquired information, the reception-side code selection unit 302 changes a selection target code into a code of which an order in the “predetermined code sequence” is earlier by a predetermined number of the code that is being selected. For example, in a case where it is determined in the determination unit 301 that the received authentication information is fraudulently acquired information when the code that is being selected is “K+1”, the reception-side code selection unit 302 newly selects a code “K+1-m” of which an order is earlier by the predetermined number of the code “K+1”.

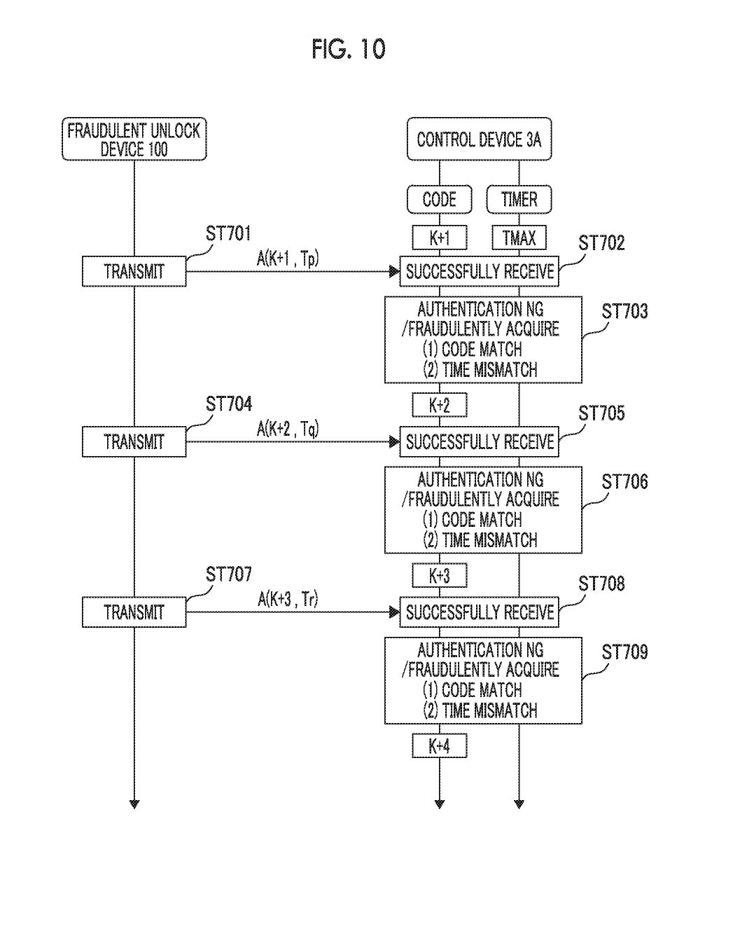

FIG. 10 is a diagram illustrating a modification example of an operation in a case where fraudulently acquired authentication information are continuously transmitted, and illustrates a case where the above-described predetermined number is “1”.

First, a code that is being selected by the reception-side code selection unit 302 is “K+1”, and the second time information generated in the second time information generation unit 303 is a maximum time “TMAX”. In this state, the authentication information A(K+1, Tp) is transmitted from the fraudulent unlock device 100, and is received by the reception unit 31 (ST701 and ST702). The code “K+1” included in the authentication information A(K+1, Tp) matches the code that is being selected in the reception-side code selection unit 302, but the first time information “Tp” included in the authentication information A(K+1, Tp) is different from the second time information “TMAX” generated in the second time information generation unit 303. Therefore, the determination unit 301 determines that the received authentication information A(K+1, Tp) is fraudulently acquired information (ST703).

Since it is determined that the authentication information A(K+1, Tp) is fraudulently acquired information in step ST703, the reception-side code selection unit 302 changes a selection target code into “K+2” progressing ahead by 1 of “K+1”.

In this state, the next authentication information A(K+2, Tq) is transmitted from the fraudulent unlock device 100, and is received by the reception unit 31 (ST704 and ST705). The code “K+2” included in this authentication information A(K+2, Tq) matches the code that is being selected in the reception-side code selection unit 302. This is due to the fact that the code has been changed in step ST703. Further, the first time information “Tq” included in the authentication information A(K+2, Tq) is different from the second time information “TMAX” generated in the second time information generation unit 303. Therefore, the determination unit 301 determines that the received authentication information A(K+2, Tq) is fraudulently acquired information again (ST706).

Since it is determined that the authentication information A(K+2, Tq) is the fraudulently acquired information in step ST706, the reception-side code selection unit 302 changes the selection target code into a code “K+3” progressing ahead by 1 of “K+2”.

In this state, when the next authentication information A(K+3, Tr) is transmitted from the fraudulent unlock device 100, the determination unit 301 determines that the authentication information A(K+3, Tr) is fraudulently acquired information, in the same manner as described above (ST707 to ST709).

According to a modification example of FIG. 10, in a case where a plurality of pieces of fraudulently acquired authentication information of which a transmission interval from the transmission device 2 is relatively short are continuously transmitted, the determination unit 301 determines that all of pieces of the authentication information are fraudulently acquired information.

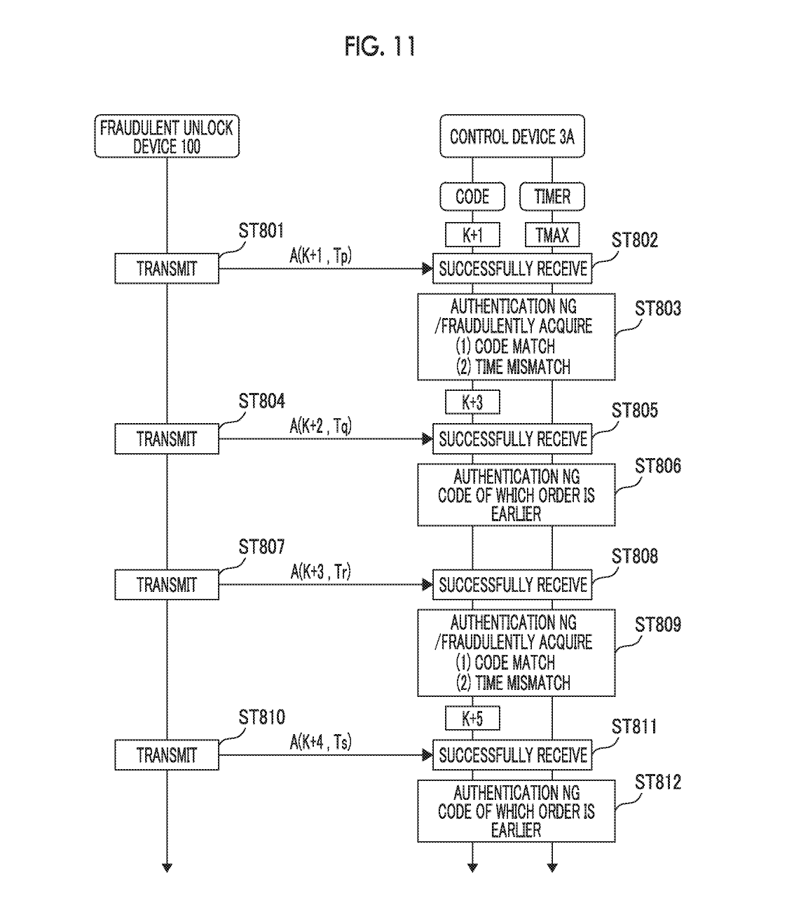

FIG. 11 is a diagram illustrating another modification example of the operation in a case where pieces of fraudulently acquired authentication information are continuously transmitted, and illustrates a case where the above-described predetermined number is “2”.

In this case, first, a code that is being selected by the reception-side code selection unit 302 is “K+1”, and the second time information generated in the second time information generation unit 303 is a maximum time “TMAX”. In this state, the authentication information A(K+1, Tp) is transmitted from the fraudulent unlock device 100, and is received by the reception unit 31 (ST801 and ST802). The code “K+1” included in the authentication information A(K+1, Tp) matches the code that is being selected in the reception-side code selection unit 302, but the first time information “Tp” included in the authentication information A(K+1, Tp) is different from the second time information “TMAX” generated in the second time information generation unit 303. Therefore, the determination unit 301 determines that the received authentication information A(K+1, Tp) is fraudulently acquired information (ST803).

Since it is determined that the authentication information A(K+1, Tp) is fraudulently acquired information in step ST803, the reception-side code selection unit 302 changes a selection target code into “K+3” progressing ahead by 2 of “K+1”.

In this state, the next authentication information A(K+2, Tq) is transmitted from the fraudulent unlock device 100 and received in the reception unit 31 (ST804 and ST805). Since a code “K+2” included in this authentication information A(K+2, Tp) has an order earlier than that of the code “K+3” that is being selected in the reception-side code selection unit 302, the determination unit 301 determines that the authentication information A(K+2, Tp) is not legitimate (ST806). In this case, since the authentication information A(K+2, Tp) is not determined to be the fraudulently acquired information, the reception-side code selection unit 302 maintains the code “K+3” that is being selected.

In this state, next authentication information A(K+3, Tr) is further transmitted from the fraudulent unlock device 100 and received in the reception unit 31 (ST807 and ST808). A code “K+3” included in the authentication information A(K+3, Tr) matches the code that is being selected in the reception-side code selection unit 302, but the first time information “Tr” included in the authentication information A(K+3, Tr) is different from the second time information “TMAX” generated in the second time information generation unit 303. Therefore, the determination unit 301 determines that the received authentication information A(K+3, Tr) is fraudulently acquired information (ST809).

Since it is determined that the authentication information A(K+3, Tr) is fraudulently acquired information in step ST809, the reception-side code selection unit 302 changes a selection target code into “K+5” progressing ahead by 2 of “K+3”.

In this state, the next authentication information A(K+4, Ts) is transmitted from the fraudulent unlock device 100, and is received in the reception unit 31 (ST810 and ST811). Since a code “K+4” included in this authentication information A(K+4, Ts) has an order earlier than that of the code “K+5” that is being selected in the reception-side code selection unit 302, the determination unit 301 determines that the authentication information A(K+4, Ts) is not legitimate (ST812). In this case, since the authentication information A(K+4, Ts) is not determined to be the fraudulently acquired information, the reception-side code selection unit 302 maintains the code “K+5” that is being selected.

According to a modification example of FIG. 11, in a case where a plurality of pieces of fraudulently acquired authentication information of which a transmission interval from the transmission device 2 is relatively short are continuously transmitted, the determination unit 301 determines that the authentication information is not legitimate or is fraudulently acquired information.

In any case, the authentication of the control device 3 using the fraudulently acquired authentication information is prevented from passing. By setting the predetermined number to a value greater than the code number a of the partial code sequence (“K”, “K+1”, . . . , “K+α”), authentication of the fraudulently acquired authentication information is more reliably prevented from passing.

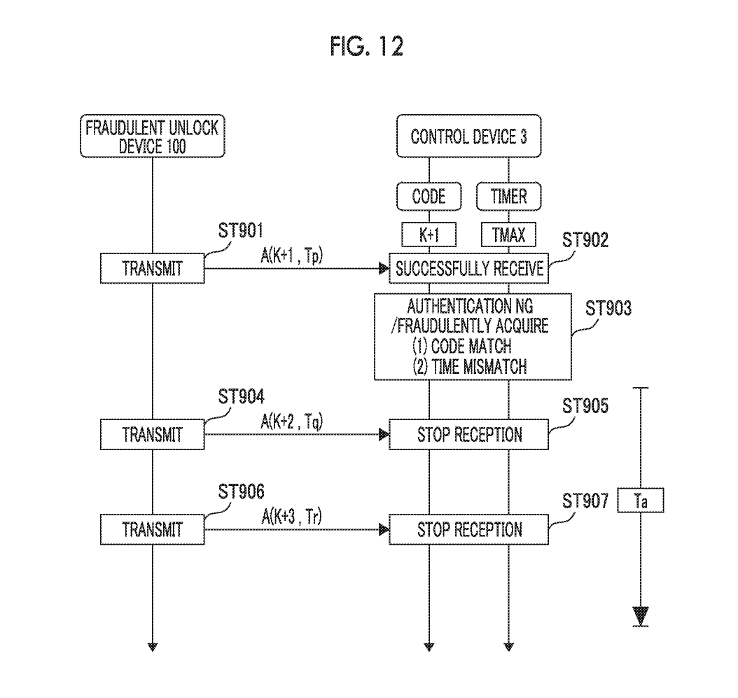

FIG. 12 is a diagram illustrating still another modification example of the operation in a case where fraudulently acquired authentication information is continuously transmitted. In this modification example, the reception unit 31 stops the reception of the authentication information until a predetermined time Ta has elapsed after the determination unit 301 determines that the authentication information is the fraudulently acquired authentication information.

In the example of FIG. 12, first, the code that is being selected in the reception-side code selection unit 302 is “K+1”, and the second time information generated in the second time information generation unit 303 is the maximum time “TMAX”. In this state, the authentication information A(K+1, Tp) is transmitted from the fraudulent unlock device 100 and received in the reception unit 31 (ST901 and ST902). The code “K+1” included in the authentication information A(K+1, Tp) matches the code that is being selected in the reception-side code selection unit 302, but the first time information “Tp” included in the authentication information A(K+1, Tp) is different from the second time information “TMAX” generated in the second time information generation unit 303.

Therefore, the determination unit 301 determines that the received authentication information A(K+1, Tp) is the fraudulently acquired information (ST903).

Since the authentication information A(K+1, Tp) is determined to be fraudulently acquired information, the reception unit 31 stops the reception of the authentication information until the predetermined time Ta has elapsed. Therefore, even when the authentication information A(K+2, Tq) and A (K+3, Tr) are transmitted from the fraudulent unlock device 100 before the predetermined time Ta elapses (ST904 and ST906), the reception unit 31 does not receive the authentication information (ST905 and ST907).

According to the modification example of FIG. 12, in a case where a plurality of fraudulently acquired consecutive authentication information are sequentially retransmitted to the control device 3, the authentication information at the head is determined to be fraudulently acquired information, and thus, the other authentication information are not received in the reception unit 31 until the predetermined time Ta has elapsed. Accordingly, the authentication in the control device 3 using the fraudulently acquired authentication information is prevented from passing.

Although the embodiments of the present invention have been described above, the present invention is not limited to the above embodiments and includes various other variations.

The above-described embodiments show examples of the present invention applied to a keyless entry system, but the present invention is not limited to the examples. That is, the present invention is widely applicable to a communication system in which a control device installed in a vehicle, a machine device, house equipment, or the like other than a car performs various controls on the basis of wireless communication with an authenticated transmission device.

1. A communication system, comprising:
a transmission device configured to wirelessly transmit authentication information; and
a control device configured to receive the authentication information and determine legitimacy of the received authentication information,
wherein the transmission device includes:
a transmission-side code selection unit configured to sequentially select one code from a predetermined code sequence each time the authentication information is to be transmitted;
a first time information generation unit configured to generate, for a current transmission of the authentication information, first time information associated with time elapsed after a last transmission of the authentication information;
an authentication information generation unit configured to generate the authentication information including the one code that is being selected in the transmission-side code selection unit and the generated first time information for the current transmission; and
a transmission unit configured to sequentially transmit the generated authentication information correspondingly to the sequential selection of the one code from the predetermined code sequence,
wherein the control device includes:
a reception unit configured to receive the authentication information;
a determination unit configured to determine legitimacy of the received authentication information;
a reception-side code selection unit configured to select a code next in order of the predetermined code sequence to a received code which is the code included in the received authentication information, if the received authentication information is determined to be legitimate in the determination unit, the selected code being held until a next code selection; and
a second time information generation unit configured to generate, for the currently received authentication information, second time information associated with time elapsed after a last determination by the determination unit that the received authentication information satisfied at least some of legitimacy conditions, and
wherein the determination unit determines whether the received authentication information has been fraudulently acquired by a third party based on a relationship between the received code and the selected code held in the reception-side code selection unit, and a relationship between the first time information included in the received authentication information and the generated second time information.

2. The communication system according to claim 1,
wherein the determination unit determines that the received authentication information has been fraudulently acquired by a third party if the received code matches the selected code that is held in the reception-side code selection unit, and a difference between the elapsed time indicated by the first time information included in the received authentication information and the elapsed time indicated by the second time information is outside a predetermined allowable range.

3. The communication system according to claim 1,
wherein the first time information generation unit counts a first time period starting from a predetermined initial value when the authentication information is transmitted by the transmission unit, stops counting when the counted first time period reaches a predetermined maximum value, and generates the first time information according to a currently counted first time period when the authentication information is generated in the authentication information generation unit, and
wherein the second time information generation unit starts counting a second time period starting from the predetermined initial value when the determination unit determines that the received authentication information satisfies at least some of legitimacy conditions, stops counting when the counted second time period reaches the predetermined maximum value, and generates the second time information according to a currently counted second time period for the determination unit to perform the determination.

4. The communication system according to claim 3,
wherein the determination unit determines that the received authentication information has been fraudulently acquired by a third party if the received code matches the selected code that is held in the reception-side code selection unit, and only one of the counted first time period indicated by the first time information and the counted second time period indicated by the second time information has the predetermined maximum value.

5. The communication system according to claim 2,
wherein the determination unit determines that the received authentication information is not legitimate if the received code in the predetermined code sequence is earlier in order thereof than that of the selected code held in the reception-side code selection unit, and
wherein the reception-side code selection unit reselects and replaces the selected code with a code which is earlier in the order of the predetermined code sequence by a predetermined number than the selected code, if the determination unit determines that the received authentication information has been fraudulently acquired by a third party.

6. The communication system according to claim 2,
wherein the determination unit determines that the received authentication information is not legitimate if the received code is not included in a partial code sequence starting with the selected code held in the reception-side code selection unit and having a predetermined length, the partial code sequence being part of the predetermined code sequence,
and wherein if the authentication information has been determined as illegitimate consecutively N times and N received codes obtained from the N consecutive determinations form a N-code sequence which matches the predetermined code sequence as a part thereof, and the N-code sequence is earlier in the order of the predetermined code sequence than the selected code held in the reception-side code selection unit, the received authentication information in the N-th determination is re-determined as legitimate.

7. The communication system according to claim 2,
wherein the reception unit stops receiving the authentication information until a predetermined time elapses after the determination unit determines that the authentication information has been fraudulently acquired by a third-party.

8. A control device for wirelessly receiving authentication information and determining legitimacy of the received authentication information, the control device comprising:
a reception unit configured to receive the authentication information which is sequentially transmitted, the authentication information including:
a code that is sequentially selected from a predetermined code sequence for a current transmission correspondingly to the sequential transmission of the authentication information; and
first time information associated with time elapsed after a last transmission of the authentication information;
a determination unit configured to determine legitimacy of the received authentication information;
a reception-side code selection unit configured to select a code next in order of the predetermined code sequence to a received code which is the code included in the received authentication information, if the received authentication information is determined to be legitimate in the determination unit, the selected code being held until a next code selection; and
a second time information generation unit configured to generate, for a current determination for the received authentication information, second time information associated with time elapsed after a last determination by the determination unit that the received authentication information satisfied at least some of legitimacy conditions,
wherein the determination unit determines legitimacy of the received authentication information based on a relationship between the received code and the selected code held in the reception-side code selection unit, and a relationship between the first time information included in the received authentication information and the generated second time information.

9. The control device according to claim 8,
wherein the determination unit determines that the received authentication information has been fraudulently acquired by a third-party if the received code matches the selected code that is being held in the reception-side code selection unit, and a difference between the elapsed time indicated by the first time information included in the received authentication information and the elapsed time indicated by the second time information is outside a predetermined allowable range.

10. The control device according to claim 8,
wherein the first time information indicates a first time period which was counted, starting from a predetermined initial value, since a last transmission of the authentication information, and
wherein the second time information generation unit starts counting a second time period starting from the predetermined initial value when the determination unit determines that the received authentication information satisfies at least some of legitimacy conditions, stops counting when the counted second time period reaches a predetermined maximum value, and generates the second time information according to a currently counted second time period for the determination unit to perform the determination.

11. The control device according to claim 10,
wherein the determination unit determines that the received authentication information has been fraudulently acquired by a third party if the received code matches the selected code that is held in the reception-side code selection unit, and only one of the counted first time period indicated by the first time information and the counted second time period indicated by the second time information has the predetermined maximum value.

12. The control device according to claim 9,
wherein the determination unit determines that the received authentication information is not legitimate if the received code in the predetermined code sequence is earlier in order thereof than that of the selected code that held in the reception-side code selection unit, and
wherein the reception-side code selection unit reselects and replaces the selected code with a code which is earlier in the order of the predetermined code sequence by a predetermined number than the selected code, if the determination unit determines that the received authentication information has been fraudulently acquired by a third party.

13. The control device according to claim 9,
wherein the reception unit stops receiving the authentication information until a predetermined time elapses after the determination unit determines that the authentication information has been fraudulently acquired by a third-party.

14. An authentication information determination method in a communication system including a transmission device configured to wirelessly transmit authentication information, and a control device configured to receive the authentication information and determines legitimacy of the received authentication information, the method comprising:
sequentially selecting, in the transmission device, one code from a predetermined code sequence each time the authentication information is to be transmitted;
generating, in the transmission device for a current transmission of the authentication information, first time information associated with time elapsed after a last transmission of the authentication information;
generating, in the transmission device, the authentication information including the one code that is being selected and the generated first time information; and
sequentially transmitting, by the transmission device, the generated authentication information correspondingly to the sequentially selecting the one code from the predetermined code sequence;
receiving, by the control device, the authentication information;
determining, in the control device, legitimacy of the received authentication information;
selecting, in the control device, a code next in order of the predetermined code sequence to a code included in the received authentication information, if the received authentication information is determined to be legitimate, the selected code being held until a next code selection; and
generating, in the control device, second time information associated with time elapsed after a last determination by the determination unit that the received authentication information satisfied at least some of legitimacy conditions,
wherein the determining in the control device includes determining whether the received authentication information has been fraudulently acquired by a third party based on a relationship between the code included in the authentication information received by the control device and the selected code that is held in the control device, and a relationship between the first time information included in the authentication information received by the control device and the second time information generated by the control device.
